(19) United States
(12) Patent Application Publication
(10) Pub. No.: US 2026/0340966 A1
(43) Pub. Date: Oct. 29, 2026

(54) DYNAMIC SERVER AUTHORITY IN VIRTUAL EXPERIENCES

(71) Applicant: Roblox Corporation, San Mateo, CA (US)

(72) Inventors: Alan JEFFREY, San Mateo, CA (US); Andreas HAEBERLEN, San Mateo, CA (US); Mitesh SHAH, San Mateo, CA (US); Stew GRANT, San Mateo, CA (US); David COPE, San Mateo, CA (US); Brad SHARP, San Mateo, CA (US)

(73) Assignee: Roblox Corporation, San Mateo, CA (US)

(21) Appl. No.: 19/187,859

(22) Filed: Apr. 23, 2025

(51) Int. Cl. G06T 19/20

(52) U.S. Cl. CPC G06T 19/20; G06T 2219/2004

(57) ABSTRACT

Implementations relate to methods, systems, and computer-readable media to adjust states of virtual objects. In some implementations, a method may include obtaining, at a client device of a user that participates in a virtual experience hosted on a server device, a program that is executable at the client device and that operates on a virtual object that is part of the virtual experience, wherein the virtual object is associated with an object state, generating an updated object state for the virtual object for a first time-step by executing the program on a processor of the client device, and after the generating, causing the virtual experience to be displayed at the client device based on the updated object state. The method may further include receiving an authoritative object state for the virtual object from the server device that is generated by executing the program on a processor of the server device.

### TECHNICAL FIELD

Embodiments relate generally to computer-based virtual experiences and computer graphics, and more particularly, to methods, systems, programs, and computer readable media to determine object states of virtual objects that are utilized in virtual experiences.

### BACKGROUND

Some online virtual experience platforms allow users to connect with each other, interact with each other (e.g., within a virtual experience), create virtual experiences, and share information with each other via the Internet. Users of online virtual experience platforms may participate in multiplayer environments (e.g., in virtual three-dimensional environments), design custom environments, design characters and avatars, design, simulate, or create animation routines that are utilized within the environments, decorate avatars, exchange virtual items/objects with other users, and so forth. Users may utilize audio, video, and other digital content to enhance the virtual experience.

User generated content (UGC) can include mechanisms and characters that are constructed from simpler virtual objects. For example, a virtual motorcar may be constructed from multiple virtual objects that are parts of the car, e.g., wheel assembly, car body, bonnet, etc. Similarly, a virtual character (e.g., an avatar) may be constructed from a combination of body parts and body joints. Scripts (programs) may be authored to control the object state(s) of virtual objects such as mechanisms and avatars. The scripts may be executed on a server device as well as on client devices.

Virtual experience platforms can utilize a server-client architecture to implement virtual experiences in order to facilitate a large number of users who may be geographically dispersed to participate in a virtual experience that can be accessed from their individual computing (client) devices. The virtual experience may be implemented such that virtual objects and environments are streamed to individual client devices from a server device. Dynamic changes in the state of virtual objects in the virtual environment during participation in a virtual experience can pose a challenge to the accurate and context appropriate streaming of virtual objects.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations relate to methods, systems, and computer-readable media to adjust states of virtual objects. In some implementations, a computer-implemented method may include obtaining, at a client device of a user that participates in a virtual experience hosted by a server device, a program that is executable at the client device and that operates on a virtual object that is part of the virtual experience, wherein the virtual object is associated with an object state, generating an updated object state for the virtual object for a first time-step by executing the program on a processor of the client device, after the generating, causing the virtual experience to be displayed at the client device, wherein the virtual object is displayed in the virtual experience based on the updated object state, receiving an authoritative object state for the virtual object from the server device, determining whether the authoritative object state for the virtual object matches the updated object state for the virtual object, and based on a determination that the authoritative object state for the virtual object does not match the updated object state for the virtual object, causing the virtual experience to be displayed at the client device based on the authoritative object state.

In some implementations, the program is associated with a scope that defines a subset of elements from elements in a data model of the virtual experience that are accessible by the program, and wherein the scope is based on a total number of the elements in the data model of the virtual experience.

In some implementations, the computer-implemented method may further include transmitting to the server device, a request for access to a second virtual object that is not included in the scope and receiving a second object state for the second virtual object, the second object state associated with a timestamp that precedes the first time-step.

In some implementations, determining whether the authoritative object state for the virtual object matches the updated object state for the virtual object may include comparing the authoritative object state and the updated object state based on an elapsed time from the first time-step to a current time at which the determining is performed.

In some implementations, the computer-implemented method may further include executing the program at the client device at a second time-step to generate a second updated object state for the virtual object, receiving, at the client device, a second authoritative object state for the virtual object from the server device, determining whether the second authoritative object state for the virtual object matches the second updated object state for the virtual object, and based on a determination that the second authoritative object state for the virtual object does not match the second updated object state for the virtual object, suspending execution of the program at the client device.

In some implementations, the computer-implemented method may further include causing the virtual experience to be displayed at the client device based on the second authoritative object state for the virtual object received from the server device. In some implementations, the computer-implemented method may further executing the program at a second client device of a second user that participates in the virtual experience, wherein executing the program at the second client device comprises generating a second updated object state for the virtual object and after the generating, causing the virtual experience to be displayed at the second client device, wherein the virtual object is displayed in the virtual experience with the second updated object state.

In some implementations, the updated object state and the second updated object state may be different, and the computer-implemented method may further include determining that the second updated object state matches an authoritative object state for the virtual object, and in response to determining that the second updated object state matches the authoritative object state, receiving at the client device the authoritative object state.

In some implementations, the virtual object includes at least one of an avatar, a sound, a texture, a chat message, or a combination thereof. In some implementations, the virtual object is an avatar, and the updated object state may include one or more of a position of the avatar in the virtual experience, a velocity of the avatar in the virtual experience, or a combination thereof.

In some implementations, the first time-step is associated with a time of the client device joining the virtual experience, and the computer-implemented method may further include prior to executing the program on the processor of the client device, receiving an initial object state for the virtual object from the server device, and causing the virtual experience to be displayed at the client device based on the initial object state.

In some implementations, a non-transitory computer-readable medium with instructions stored thereon that, upon execution by a processing device, cause the processing device to perform operations that include obtaining, at a client device of a user that participates in a virtual experience hosted by a server device, a program that is executable at the client device and that operates on a virtual object that is part of the virtual experience, wherein the virtual object is associated with an object state, generating an updated object state for the virtual object for a first time-step by executing the program on a processor of the client device, after the generating, causing the virtual experience to be displayed at the client device, wherein the virtual object is displayed in the virtual experience based on the updated object state, receiving an authoritative object state for the virtual object from the server device, determining whether the authoritative object state for the virtual object matches the updated object state for the virtual object, and based on a determination that the authoritative object state for the virtual object does not match the updated object state for the virtual object, causing the virtual experience to be displayed at the client device based on the authoritative object state.

In some implementations, a system may include a memory with instructions stored thereon, and a processing device, coupled to the memory, the processing device configured to access the memory and execute the instructions, wherein the instructions cause the processing device to perform operations that include obtaining, at a client device of a user that participates in a virtual experience hosted by a server device, a program that is executable at the client device and that operates on a virtual object that is part of the virtual experience, wherein the virtual object is associated with an object state, generating an updated object state for the virtual object for a first time-step by executing the program on a processor of the client device, after the generating, causing the virtual experience to be displayed at the client device, wherein the virtual object is displayed in the virtual experience based on the updated object state, receiving an authoritative object state for the virtual object from the server device, determining whether the authoritative object state for the virtual object matches the updated object state for the virtual object, and based on a determination that the authoritative object state for the virtual object does not match the updated object state for the virtual object, causing the virtual experience to be displayed at the client device based on the authoritative object state.

### BRIEF DESCRIPTION OF THE DRAWINGS

FIG. 1 is a diagram of an example environment to determine object states of virtual objects utilized in virtual experiences, in accordance with some implementations.

FIG. 2A depicts an example scene from a virtual experience implemented over a client-server architecture, in accordance with some implementations.

FIGS. 2B-2D depict examples of replication of data objects between a server device and client devices participating in a virtual experience, in accordance with some implementations.

FIG. 3 illustrates an example method to determine object states of virtual objects utilized in virtual experiences, in accordance with some implementations.

FIG. 4 is an example program to determine an object state of a virtual object, in accordance with some implementations.

FIG. 5 depicts example states of virtual objects stored in a workspace (memory) of a server device and a workspace (memory) of a client device that correspond to an example virtual experience, in accordance with some implementations.

FIG. 6 illustrates various stages of the updation and display of virtual objects during an implementation of dynamic server authority in a virtual experience, in accordance with some implementations.

FIG. 7 illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some embodiments”, “an embodiment”, “an example embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

Online virtual experience platforms (also referred to as “user-generated content platforms” or “user-generated content systems”) offer a variety of ways for users to interact with one another. For example, users of an online virtual experience platform may work together towards a common goal, share various virtual experience items, send electronic messages to one another, and so forth. Users of an online virtual experience platform may join virtual experience(s), e.g., games or other experiences as virtual characters, playing specific roles. For example, a virtual character may be part of a team or multiplayer environment wherein each character is assigned a certain role and has associated parameters, e.g., clothing, armor, weaponry, skills, etc. that correspond to the role. In another example, a virtual character may be joined by computer-generated characters, e.g., when a single player is part of a game.

A virtual experience platform may enable users (developers) of the platform to create virtual objects, new games, and/or characters. For example, users of the online gaming platform may be enabled to create, design, and/or customize new characters (avatars), new animation packages, new three-dimensional objects, etc. and make them available to other users.

In some implementations, the set of virtual objects to be rendered locally on the client device are stored in a workspace (memory) of the client device, which serves as a repository to hold virtual objects that exist in the virtual experience (e.g., a three-dimensional virtual world). The contents of the workspace are updated, e.g., as virtual objects move around within the virtual environment, as virtual objects get destroyed within the virtual environment, as new virtual objects get added to the virtual environment, etc. At suitable times, e.g., corresponding to a refresh rate, a display screen of the local device may be updated based on an updated object state of the virtual objects in the workspace of the client device.

Streaming and local rendering of virtual objects may not be limited to display of virtual objects. In some implementations, the object state of a virtual object may be utilized to update a non-visual attribute if a virtual experience. For example, in some implementations, rendering of virtual objects may include playback of a sound (e.g., where a virtual object corresponds to a sound file), application of a texture on a virtual object (e.g., where a virtual object corresponds to an image), execution of a script locally on the client device (e.g., where a virtual object corresponds to a script and where an object state specifies execution of a script), etc.

Virtual objects may also include sounds, e.g., songs, etc., that may be played back via client devices; scores associated with games where a leaderboard or scoreboard is updated, virtual objects that may be obtained via completion of milestones within a virtual experience, an event tracker within a virtual experience, etc.

Streaming the virtual objects as individual objects (instances) over a network can lead to behavior problems during rendering of the virtual experience (e.g., gameplay). In some scenarios, individual streaming of virtual objects may complicate the programming model that developers that build virtual experiences utilize.

In some implementations, a virtual experience can include virtual representations of players, non-player characters (NPCs), tools, accessories, assemblies, mechanisms etc., that are displayed on client (local) devices. In some implementations, the virtual representations may be user generated content that is uploaded to the virtual experience platform and made available to other developer users for use.

During a virtual experience, the state (object state) of a virtual object can undergo changes. For example, the object state of a virtual object that is a vehicle, e.g., a car, may include a position and velocity of a virtual object that changes based on the movements of the car within the virtual experience. Based on a determined object state of the virtual object, the virtual object may be caused to be displayed, e.g., on a screen of one or more client devices participating in the virtual experience. In some implementations, a virtual experience may utilize a data model that is a hierarchical structure of objects that represent different types of virtual objects associated with the virtual experience, e.g., three-dimensional (3D) elements, terrain, scripts, player data, etc. In some implementations, the data model acts as the source of truth for the state of the virtual experience.

In some implementations, an object state of a virtual object may be configured, e.g., initialized, adjusted, etc., during a virtual experience via scripts (programs) that are executed on a processor of a device, e.g., a client device or server device. In some implementations, the scripts may be text files that let a developer user add custom, dynamic behavior to a virtual experience. In some implementations, the scripts (programs) are utilized to determine the state of virtual objects. Additionally, scripts may be utilized to trigger events within a virtual experience, e.g., an in-game event, respond to input(s) from a participant in a virtual experience, record (e.g., save) participant data, create leaderboards for a virtual experience, spawn new virtual characters within a virtual experience, control non-player character (NPC) behavior, etc.

In some implementations, scripts (executable programs) may be provided by a virtual experience platform for commonly performed tasks that developer users may include within a virtual experience. In some implementations, in addition to platform provided scripts, developer users may be enabled to create user written scripts that enable customization of a virtual experience.

In order to provide a superior user experience, script execution may be divided into client-side execution and server-side execution. For example, physics mechanisms associated with a user may be simulated on a local client device instead of being simulated on a server device for faster response and less laggy simulation and rendering of virtual objects. In order to support complex physical mechanisms while also aiming to provide a smooth and responsive experience for participants, e.g., players, a physics engine may be utilized that includes a distributed physics solver (system) in which computations (e.g., determining solutions to the equations of motion of one or more physical objects) are distributed between the server and all connected client devices (clients). A virtual experience engine (e.g., that executes on a server device) may assign network ownership of physically simulated virtual objects (e.g., BaseParts) to either a client device or server device to divide the work of calculating physics.

Client devices can provide more responsive physics interactions with parts that they own, since there is no latency from communication with the server. Performing physics calculations in a distributed manner by utilizing network ownership units (NOU) additionally can also improve server performance because physics computations can be split up among individual client devices, enabling the server to prioritize other tasks.

In some implementations, a network ownership unit includes a plurality of physically connected objects that are to be simulated together on a single authoritative client device. Assignments of a group of physically connected virtual objects to a specific device that is to act as a NOU for the group of physically connected virtual objects may be determined, e.g., at a server device. Accordingly, a virtual experience platform may provide support for scripts that may be targeted at particular types of devices, e.g., server devices and client devices. Authority for determination of objects states for each virtual object is assigned to a corresponding type of device.

In some implementations, scripts may be utilized to adjust object states associated with script related exploits. For example, a script related exploit may be setting a value (e.g., JumpPower) on a client device based on a script that enables a virtual avatar to perform extra high jumps in a basketball game.

However, ceding authority for simulation and determining object states to a client device (as opposed to a server device) can pose certain challenges. For example, in some scenarios, a particular client device may not have sufficient computational power and/or memory capacity to meet real-time simulation requirements. In some other scenarios, participant users may modify scripts and execute a modified script to obtain unfair advantages in a virtual experience. For example, a user modified script may enable a user to operate a virtual object at a higher-than-permitted speed and gain an advantage over other participants in the virtual experience.

Since participating users may attempt to exploit or manipulate the game, especially when client devices are given the ability to run parts of it authoritatively, it is crucial to have mechanisms to identify when a client device is acting incorrectly and to fix the issue. However, balancing detection and correction without compromising the player experience can be challenging.

In some implementations, full server authority may be implemented by running (executing) all game logic on the server as a way to prevent cheating. However, this comes with trade-offs. Server-side execution can lead to increased latency since client devices are unable to speculatively determine virtual object states. Additionally, scalability in full server authority implementations poses challenges to scalability since the server device has to perform simulations associated with all client devices.

In some implementations, dynamic server authority may be implemented via distributed scripts wherein authority for object states for virtual objects is retained at a server device (or a set of server devices), and where the authority may be conditionally transferred to client devices. Distributed scripts offer a simplified approach to programming scripts on virtual experience platforms and enable the development of server authority and large-scale virtual experiences.

On platforms that support user generated content (UGC), developer users have needed to consider the difference between client devices and server devices and how to write scripts accordingly (e.g., such that scripts can execute on devices with varying computational capabilities, memory availability, processor types, etc.). The use of distributed scripts enables a device and execution location agnostic programming experience where developer users write scripts (code) in a unified manner (without regard whether the script is intended for execution on a server device or a client device) and the best execution location for execution is determined by the virtual experience platform.

In addition, distributed scripts enable developer users (creators) to associate a single script instance with multiple virtual objects (data model objects) making it easy to reuse them throughout a virtual experience. Thus, a script may have a one-to-many association with virtual objects, referred to as behaviors and individual instantiations may be referred to as behavior objects. In some implementations, the distributed scripts may be implemented via an object-oriented design where the behavior state is both self-contained and stored entirely on the data model to reduce external dependence. The data model is leveraged to replicate and migrate behavior object(s).

Various implementations described herein provide several technical advantages and solutions to technical problems. For example, when utilizing distributed scripts, developer users need not distinguish between client-side and server-side operations. This may particularly benefit new creators, since any potential confusion between client-side and server-side operations can be avoided. Additionally, the developer users do not need to distinguish between application programming interfaces (APIs) that may be restricted to either a client device or a server device.

In some implementations, distributed scripts may be utilized in conjunction with multiple instances of virtual objects. This offers advantages over current approaches where scripts are duplicated across instances in a virtual experience. The latter approach (duplicated scripts), while initially convenient, can become difficult to manage when updating all scripts. Changes must be made to every copy of a script, leading to potential inconsistencies and increasing the likelihood of errors, especially as the number of duplicates grows.

Distributed scripts as described with reference to implementations herein can enable a greater degree of parallelism that is available in modern processors. Additionally, duplication of initialization can be avoided with distributed scripts when compared to duplicated scripts. When scripts are duplicated, they are each initialized separately, even if they share a common set of variables or modules. This may lead to unnecessary memory usage as the same data is loaded repeatedly across different scripts.

The use of distributed scripts can enable efficient resource usage, e.g., of processors and/or memory. Currently, a script cannot be put to sleep without restarting it. This limitation means that a script continues to run even when not needed, leading to inefficient resource usage.

Distributed scripts as described in various implementations herein provide support for persistent storage of states across instances unlike traditionally implemented scripts where script states are stored within script variables that are commonly tied to a single virtual machine (VM). This makes it hard to share data between VMs, execute the scripts in parallel, and distribute them to clients in scenarios where the scripts are to be executed speculatively to mitigate latency.

Distributed scripts may also enable additional predictability in implementations of server authority since additional controls may be available, e.g., use of configurable seeds for the generation of random numbers. This may enable greater consistency of random number generation procedures, even when implemented across different processors/nodes. For example, a seed value of one or more random number generators utilized by a distributed scripts may be synchronized in order to make the generators output the same sequence of pseudo random numbers on multiple client devices.

In some implementations, a manner in which random number generators are initially seeded may be modified using distributed scripts such that the created (generated) pseudo random sequences from a first random number generator that is seeded with a first initial seed is different from a second pseudo random sequence that is generated by a second random number generator that is seeded with a second initial seed. Effectively the random number generators can appear to be random even though the sequences on both the client device and server device are predictable.

A technical problem is the provision of automatic, accurate, scalable, cost-effective, and reliable tools for creation (generation) of virtual experiences. Various implementations described herein may support users to generate virtual experiences that have reduced lag/latency while maintaining accurate rendering of virtual objects within the virtual experiences.

Techniques described herein can enable determination of object states of virtual objects in a virtual experience platform via the utilization of distributed scripts. Utilization of distributed scripts can enable quick response times for users and a better user experience, while also enabling dynamic server authority within the virtual experience platform.

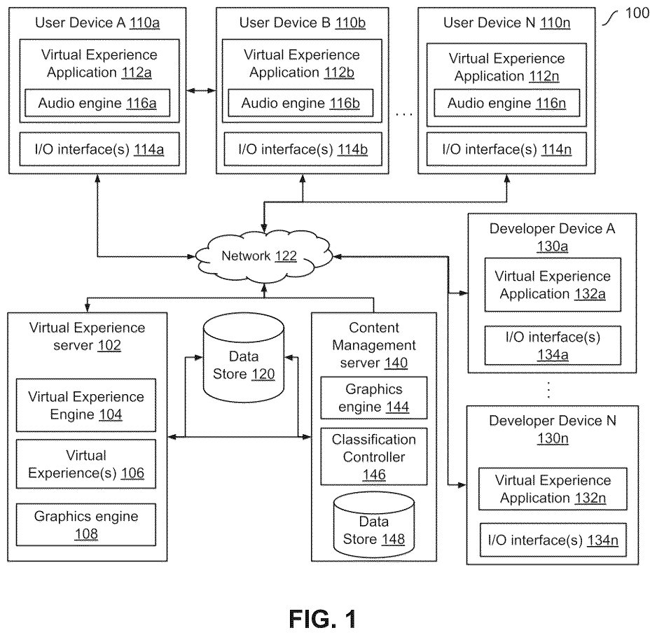

FIG. 1 is a diagram of an example environment to determine object states of virtual objects utilized in virtual experiences, in accordance with some implementations. FIG. 1 and other figures use like reference numerals to identify like elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, user devices 110a, 110b, and 110n (generally referred to as “user device(s) 110” herein), and developer devices 130a and 130n (generally referred to as “developer device(s) 130” herein), virtual experience server 102, content management server 140, data store 120, user devices 110, and developer devices 130 are coupled via network 122. In some implementations, user devices(s) 110 and developer device(s) 130 may refer to the same or same type of device.

Online virtual experience server 102 can include a virtual experience engine 104, one or more virtual experience(s) 106, and graphics engine 108. A user device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc. The input/output devices can also include accessory devices that are connected to the user device by means of a cable (wired) or that are wirelessly connected.

Content management server 140 can include a graphics engine 144, and a classification controller 146. In some implementations, the content management server may include a plurality of servers. In some implementations, the plurality of servers may be arranged in a hierarchy, e.g., based on respective prioritization values assigned to content sources.

Graphics engine 144 may be utilized for the rendering of one or more objects, e.g., 3D objects associated with the virtual environment. Classification controller 146 may be utilized to classify assets such as 3D objects and for the detection of inauthentic digital assets, etc. Data store 148 may be utilized to store a search index, model information, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, a cloud storage system, or another type of component or device capable of storing data. The data store 120 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, a distributed computing system, a cloud computing system, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on user devices 110.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be an online gaming server. For example, the virtual experience server may provide single-player or multiplayer games to a community of users that may access or interact with games using user devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to the interaction of one or more players using user devices (e.g., 110) within a game (e.g., game that is part of virtual experience 106) or the presentation of the interaction on a display or other output device (e.g., 114) of a user device 110.

In some implementations, a virtual experience 106 can include an electronic file that can be executed or loaded using software, firmware or hardware configured to present the game content (e.g., digital media item) to an entity. In some implementations, a virtual experience application 112 may be executed and a virtual experience 106 executed in connection with a virtual experience engine 104. In some implementations, a virtual experience 106 that is a game may have a common set of rules or common goal, and the environment of a virtual experience 106 shares the common set of rules or common goal. In some implementations, different games may have different rules or goals from one another.

In some implementations, virtual experience(s) may have one or more environments (also referred to as “gaming environments” or “virtual environments” herein) where multiple environments may be linked. An example of an environment may be a three-dimensional (3D) environment. The one or more environments of a virtual experience application 112 may be collectively referred to a “world” or “gaming world” or “virtual world” or “universe” herein. An example of a world may be a 3D world of a virtual experience 106. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online virtual experience server 102 can host one or more virtual experiences 106 and can permit users to interact with the virtual experiences 106 using a virtual experience application 112 of user devices 110. Users of the online virtual experience server 102 may play, create, interact with, or build virtual experiences 106, communicate with other users, and/or create and build objects (e.g., also referred to as “item(s)” or “game objects” or “virtual game item(s)” herein) of virtual experiences 106. For example, in generating user-generated virtual items, users may create characters, decoration for the characters, one or more virtual environments for an interactive game, or build structures used in a game. In some implementations, users may buy, sell, or trade virtual game objects, such as in-platform currency (e.g., virtual currency), with other users of the online virtual experience server 102. In some implementations, online virtual experience server 102 may transmit game content to virtual experience applications (e.g., 112). In some implementations, game content (also referred to as “content” herein) may refer to any data or software instructions (e.g., game objects, game, user information, video, images, commands, media item, etc.) associated with online virtual experience server 102 or virtual experience applications. In some implementations, game objects (e.g., also referred to as “item(s)” or “objects” or “virtual objects” or “virtual game item(s)” herein) may refer to objects that are used, created, shared or otherwise depicted in virtual experiences 106 of the online virtual experience server 102 or virtual experience applications 112 of the user devices 110. For example, game objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration, rather than limitation. In some implementations, online virtual experience server 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual application 106 may be associated with a particular user or a particular group of users (e.g., a private game), or made widely available to users with access to the online virtual experience server 102 (e.g., a public game). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or user devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the game (e.g., rendering commands, collision commands, physics commands, etc.) In some implementations, virtual experience applications 112 of user devices 110, may work independently, in collaboration with virtual experience engine 104 of online virtual experience server 102, or a combination of both.

In some implementations, both the online virtual experience server 102 and user devices 110 may execute a virtual experience engine and a virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of user device 110. In some implementations, each virtual application 106 may have a different ratio between the virtual experience engine functions that are performed on the online virtual experience server 102 and the virtual experience engine functions that are performed on the user devices 110. For example, the virtual experience engine 104 of the online virtual experience server 102 may be used to generate physics commands in cases where there is a collision between at least two virtual application objects, while the additional virtual experience engine functionality (e.g., generate rendering commands) may be offloaded to the user device 110. In some implementations, the ratio of virtual experience engine functions performed on the online virtual experience server 102 and user device 110 may be changed (e.g., dynamically) based on gameplay conditions. For example, if the number of users participating in gameplay of a particular virtual application 106 exceeds a threshold number, the online virtual experience server 102 may perform one or more virtual experience engine functions that were previously performed by the user devices 110.

For example, users may be playing a virtual application 106 on user devices 110, and may send control instructions (e.g., user inputs, such as right, left, up, down, user election, or character position and velocity information, etc.) to the online virtual experience server 102. Subsequent to receiving control instructions from the user devices 110, the online virtual experience server 102 may send gameplay instructions (e.g., position and velocity information of the characters participating in the group gameplay or commands, such as rendering commands, collision commands, etc.) to the user devices 110 based on control instructions. For instance, the online virtual experience server 102 may perform one or more logical operations (e.g., using virtual experience engine 104) on the control instructions to generate gameplay instruction(s) for the user devices 110. In other instances, online virtual experience server 102 may pass one or more or the control instructions from one user device 110 to other user devices (e.g., from user device 110a to user device 110b) participating in the virtual application 106. The user devices 110 may use the gameplay instructions and render the gameplay for presentation on the displays of user devices 110.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a user device 110 to another user device (e.g., from user device 110b to user device 110n), where the other user device generates gameplay instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that allow a user device 110 to render gameplay of a game, such as a multiplayer game. The gameplay instructions may include one or more of user input (e.g., control instructions), character position and velocity information, or commands (e.g., physics commands, rendering commands, collision commands, etc.).

In some implementations, the online virtual experience server 102 may store characters created by users in the data store 120. In some implementations, the online virtual experience server 102 maintains a character catalog and game catalog that may be presented to users. In some implementations, the game catalog includes images of virtual experiences stored on the online virtual experience server 102. In addition, a user may select a character (e.g., a character created by the user or other user) from the character catalog to participate in the chosen game. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the virtual experience platform may support three-dimensional (3D) objects that are represented by a 3D model and includes a surface representation used to draw the character or object (also known as a skin or mesh) and a hierarchical set of interconnected bones (also known as a skeleton or rig). The rig may be utilized to animate the object and to simulate motion of the object. The 3D model may be represented as a data structure, and one or more parameters of the data structure may be modified to change various properties of the character, e.g., dimensions (height, width, girth, etc.); shape; movement style; number/type of parts; proportion, etc.

In some implementations, the 3D model may include a 3D mesh. The 3D mesh may define a three-dimensional structure of the unauthenticated virtual 3D object. In some implementations, the 3D mesh may also define one or more surfaces of the 3D object. In some implementations, the 3D object may be a virtual avatar, e.g., a virtual character such as a humanoid character, an animal-character, a robot-character, etc.

In some implementations, the mesh may be received (imported) in a FBX file format. The mesh file includes data that provides dimensional data about polygons that comprise the virtual 3D object and UV map data that describes how to attach portions of texture to various polygons that comprise the 3D object. In some implementations, the 3D object may correspond to an accessory, e.g., a hat, a weapon, a piece of clothing, etc. worn by a virtual avatar or otherwise depicted with reference to a virtual avatar.

In some implementations, a platform may enable users to submit (upload) candidate 3D objects for utilization on the platform. A virtual experience development environment (developer tool) may be provided by the platform, in accordance with some implementations. The virtual experience development environment may provide a user interface that enables a developer user to design and/or create virtual experiences, e.g. games. The virtual experience development environment may be a client-based tool (e.g., downloaded and installed on a client device, and operated from the client device), a server-based tool (e.g., installed and executed at a server that is remote from the client device, and accessed and operated by the client device), or a combination of both client-based and service-based elements.

The virtual experience development environment may be operated by a developer of a virtual experience, e.g., a game developer or any other person who seeks to create a virtual experience that may be published by an online virtual experience platform and utilized by others. The user interface of the virtual experience development environment may be rendered on a display screen of a client device, e.g., such as a developer device 130 described with reference to FIG. 1, so as to enable the creator/developer to interact with the development environment using actions such as typing, highlighting, selecting, drag and drop, clicking, and so forth via a mouse, keyboard, or other input device configured to communicate with the user interface. The user interface may include a menu bar, a tool bar, a workspace pane, and a plurality of secondary panes. Depending on the particular implementation, the user interface may include alternative or additional elements, arrangements, operational features, etc. of the virtual experience development environment than what is shown and described herein.

A developer user (creator) may utilize the virtual experience development environment to create virtual experiences. As part of the development process, the developer/creator may upload various types of digital content such as object files (meshes), image files, audio files, short videos, etc., to enhance the virtual experience.

In implementations where the 3D object is an accessory, data indicative of use of the object in a virtual experience may also be received. For example, a “shoe” object may include annotations indicating that the object can be depicted as being worn on the feet of a virtual humanoid character, while a “shirt” object may include annotations that it may be depicted as being worn on the torso of a virtual humanoid character.

In some implementations, the 3D model may further include texture information associated with the 3D object. For example, texture information may indicate color and/or pattern of an outer surface of the 3D object. The texture information may enable varying degrees of transparency, reflectiveness, degrees of diffusiveness, material properties, and refractory behavior of the textures and meshes associated with the 3D object. Examples of textures include plastic, cloth, grass, a pane of light blue glass, ice, water, concrete, brick, carpet, wood, etc.

In some implementations, the user device(s) 110 may each include computing devices such as personal computers (PCs), mobile devices (e.g., laptops, mobile phones, smart phones, tablet computers, or netbook computers), network-connected televisions, gaming consoles, etc. In some implementations, a user device 110 may also be referred to as a “client device.” In some implementations, one or more user devices 110 may connect to the online virtual experience server 102 at any given moment. It may be noted that the number of user devices 110 is provided as illustration. In some implementations, any number of user devices 110 may be used.

In some implementations, each user device 110 may include an instance of the virtual experience application 112, respectively. In one implementation, the virtual experience application 112 may permit users to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to user device 110 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

In some implementations, the virtual experience application may include an audio engine 116 that is installed on the user device, and which enables the playback of sounds on the user device. In some implementations, audio engine 116 may act cooperatively with audio engine 144 that is installed on the sound server.

According to aspects of the disclosure, the virtual experience application may be an online virtual experience server application for users to build, create, edit, upload content to the online virtual experience server 102 as well as interact with online virtual experience server 102 (e.g., participate in virtual experiences 106 hosted by online virtual experience server 102). As such, the virtual experience application may be provided to the user device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a virtual experience program) that is installed and executes local to user device 130 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or play virtual experiences 106 hosted by online virtual experience server 102). As such, the virtual experience application may be provided to the user device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual applications 106 developed, hosted, or provided by a virtual experience application developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience application developer may obtain access to virtual experience application objects, such as in-platform currency (e.g., virtual currency), avatars, special powers, accessories, that are owned by or associated with other users.

In general, functions described in one implementation as being performed by the online virtual experience server 102 can also be performed by the user device(s) 110, or a server, in other implementations if appropriate. In addition, the functionality attributed to a particular component can be performed by different or multiple components operating together. The online virtual experience server 102 can also be accessed as a service provided to other systems or devices through appropriate application programming interfaces (APIs) and thus is not limited to use in websites.

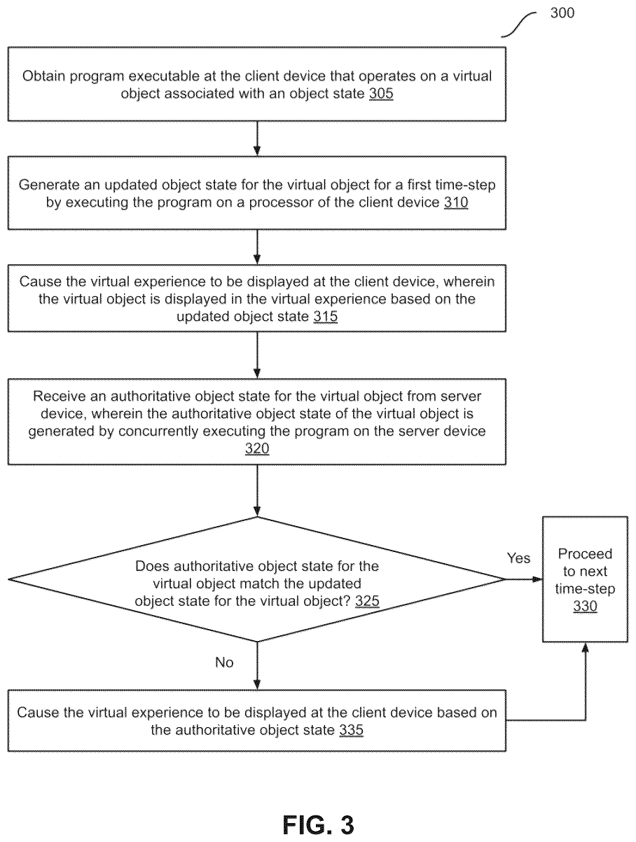

In some implementations, online virtual experience server 102 may include a graphics engine 108. In some implementations, the graphics engine 108 may be a system, application, or module that permits the online virtual experience server 102 to provide graphics and animation capability. In some implementations, the graphics engine 108, and/or content management server 140 may perform one or more of the operations described below in connection with the flowcharts and workflows shown in FIG. 3.

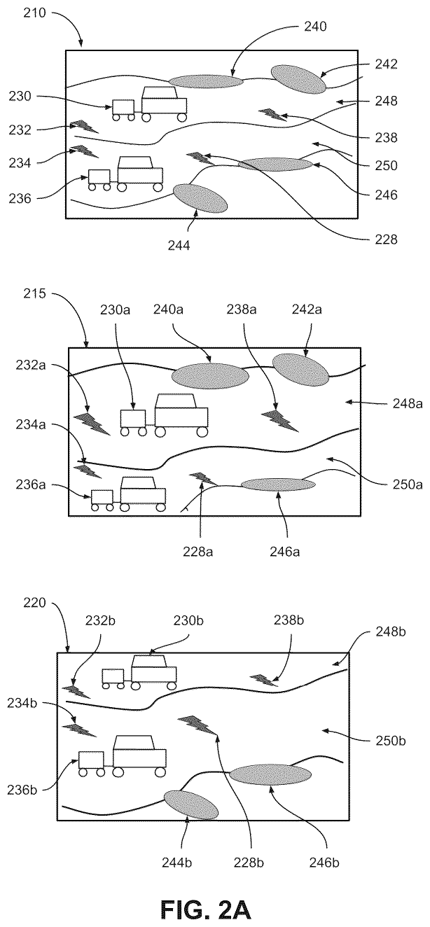

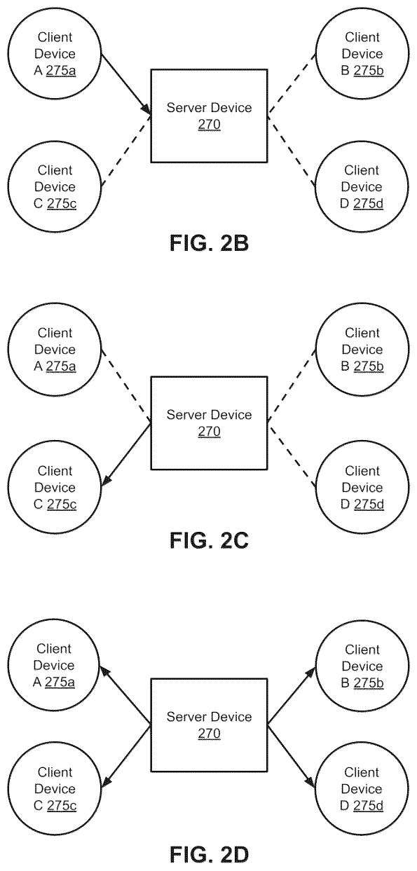

FIG. 2A depicts an example scene from a virtual experience implemented over a client-server architecture, in accordance with some implementations. In this illustrative example, the virtual experience is a multi-player car racing game that includes obstacles (puddles) and boosts (lightning bolts).

Specifically, FIG. 2A depicts a scene from a virtual experience that includes a representation 210 of a plurality of virtual objects at a server device, as well as representations 215 and 220 of the scene at a first client device and a second client device respectively. Each of the client devices may be associated with respective players, and who may be participating in a common virtual experience on the virtual experience platform.

The representation 210 of the scene at the server device includes a first car 230 traveling on a first race track 248, a second car 236 traveling on a second race track 250. The course additionally includes lightning bolts 228, 232, 234, and 238 at different locations over the course that act as boosters (e.g., a vehicle that traverses a lightning bolt can travel at double its default maximum speed) and puddles 240, 242, 244, and 246 spread over the course that act as obstacles (e.g., a vehicle that traverses a puddle can only travel at half its default maximum speed).

FIG. 2A additionally depicts the scene as streamed to respective client devices and as representation 215 and representation 220. In order to provide a superior user experience, the virtual experience platform may enable in-experience content streaming, whereby content, e.g., virtual objects, terrain, and/or other content streamed to each client device may be based on a particular context of a participating user, e.g., a position of a virtual character (avatar) associated with the player in the virtual experience, regions of interest in the virtual experience to the participating player, etc.

Accordingly, the scene rendered on client device 215 includes a more prominent display of virtual objects associated with the participating user of client device 215. For example, the scene rendered on client device 215 includes a more prominent display of the first race track 248a, the first car 230a, puddles 240a and 242a, and lightning bolts 232a and 238a. Proximate virtual objects such as second car 236a, second race track 250 a, lightning bolts 228 a and 234 a, as well as puddle 246a are also rendered to provide the participating user associated with client device 215 with a visual representation of a surrounding context.

Similarly, the scene rendered on client device 220 includes a more prominent display of the second race track 250b, car 236b, track 250b, lightning bolts 228b and 234b, and puddles 244b and 246b. Proximate virtual objects to the streamed region, e.g., car 230b, lightning bolts 232b and 238b, and track 248b are also displayed (rendered) on client device 220.

The rendering of virtual objects for on-screen display is based on their respective object states, as recorded in a data model that includes virtual objects that are associated with a virtual experience. In some implementations, particularly for virtual experiences that include a relatively large number of virtual objects, a subset of virtual objects may be tracked at each client device and adjusted dynamically as the object states change during the virtual experience.

In some implementations, the object state of virtual objects is stored on each client device that includes storage (workspace), e.g., memory, for virtual objects that are to be rendered on the client device. For a superior user experience, the object state of virtual objects must be determined accurately while meeting real-time requirements, as well as be synchronized and/or replicated across different devices participating in the virtual experience.

FIGS. 2B-2D depict examples of replication of data objects between a server device 270 and client devices 275a, 275b, 275c, and 275d participating in a virtual experience, in accordance with some implementations.

Data model changes can occur in a variety of cases, such as when a new virtual object is added to a virtual experience and/or when an object state (property) of an existing virtual object is modified. This typically occurs when a script on the server device or client device makes a change that is to be reflected on the other side of the client device-server device boundary. FIGS. 2B-2D depict some common scenarios for data replication.

FIG. 2B depicts communication from a single client device (Client Device A 275a) to the server device 270. For example, a user associated with client device A 275a may press a key to drink an invisibility potion (in the virtual experience that they participate in), and a corresponding message is transmitted from client device 275a to the server device 270 to make that player's character invisible to other players in that virtual experience.

FIG. 2C depicts communication from the server device 270 to a single client device (Client Device C 275c). For example, a player may join a virtual experience using client device 275c and subsequently) a set of virtual objects is transmitted (streamed) from the server device 270 to client device 275c in order to populate the player's inventory with a set of items.

FIG. 2D depicts communication from the server device 270 to all connected client devices. For example, a countdown timer maintained by server device 270 may be broadcast to all devices associated with participants in a race.

Replication between the server device and client devices participating in the virtual experience ensures a consistent user experience for all participating users. Accordingly, in some implementations, at periodic intervals (or on-demand), the server device provides updates to connected client devices, thereby keeping the data model in sync across the server and client devices through a process called replication, which synchronizes the data model, physics simulation, chat messages, etc. Replication logic is provided on both the client device(s) and server device(s) to ensure synchronization.

In some implementations, an initial state of a virtual object may be transmitted from the server device to client devices. A portion of the script state may be determined by executing initialization code on the client device.

In some implementations, a runtime environment of the virtual experience includes an indicator of objects in the virtual world that are predictable (e.g., potentially predictable). In some implementations, creators (developers) of a virtual experience may provide an indication of predictable virtual objects in the virtual experience. A virtual experience engine may, at runtime, utilize available information regarding the virtual experience, policies, heuristics, etc., to determine which objects should be predicted on a given client device.

For example, on a low-end client device, only a virtual avatar associated with a player (user of the client device) and corresponding tools they are holding may be predicted. On a high-end device, a larger set of objects near the player or near their field of view may be predicted. In some implementations, the set of predicted objects may be adjusted dynamically based on the complexity of the world near the player, the amount of available CPU and memory available on the client device (which may change over time), etc.

FIG. 3 illustrates an example method to determine object states of virtual objects utilized in virtual experiences, in accordance with some implementations.

In some implementations, method 300 can be implemented, for example, on virtual experience 102 described with reference to FIG. 1. In some implementations, some or all portions of the method 300 can be implemented on one or more client devices 110 as shown in FIG. 1, on one or more developer devices 130, or on one or more server device(s) 102, and/or on a combination of developer device(s), server device(s), and client device(s). In the examples described, the implementing system includes one or more digital processors or processing circuitry (“processors”), and one or more storage devices (e.g., a data store 120 or other storage). In some implementations, different components of one or more servers and/or clients can perform different blocks or other parts of method 300. In some examples, a first device is described as performing blocks of method 300. Some implementations can have one or more blocks of method 300 performed by one or more other devices (e.g., other client devices or server devices) that can send results or data to the first device.

In some implementations, method 300, or portions of the method, can be initiated automatically by a system. In some implementations, the implementing system is a first device. For example, the method (or portions thereof) can be periodically performed, or performed based on one or more particular events or conditions, e.g., a client device joining a virtual experience, a launch of a virtual experience at a virtual experience platform, a predetermined time period having expired since the last performance of method 300, and/or one or more other conditions occurring which can be specified in settings read by the method. Method 300 may begin at block 305.

At block 305, a program (distributed script) is obtained at a client device of a user that participates in a virtual experience hosted on a server device. In some implementations, the program is executable at the client device and operates on a virtual object that is part of the virtual experience. In some implementations, the virtual object may be associated with an object state.

In some implementations, the virtual objects can include avatars, mechanisms, sounds, events, camera views, etc., where the object state of the virtual object is determined by the program (distributed script). The program may be stored on the virtual experience platform and retrieved at a time of launch of a virtual experience. In some implementations, the program may be utilized to initialize variables associated with virtual objects of the virtual experience.

In some implementations, the virtual object may include at least one of an avatar, a sound, a texture, a chat message, or a combination thereof. The updated object state may include an attribute of the virtual object, e.g., one or more of a position and a velocity of the avatar in the virtual experience.

In some implementations, the program may be in the form of a text file that includes code written to create custom behaviors for a virtual experience. The program can be used to make the virtual experience more interactive by triggering events, responding to user input, etc. In some implementations, the program may be written in a scripting language previously approved and/or authorized for use.

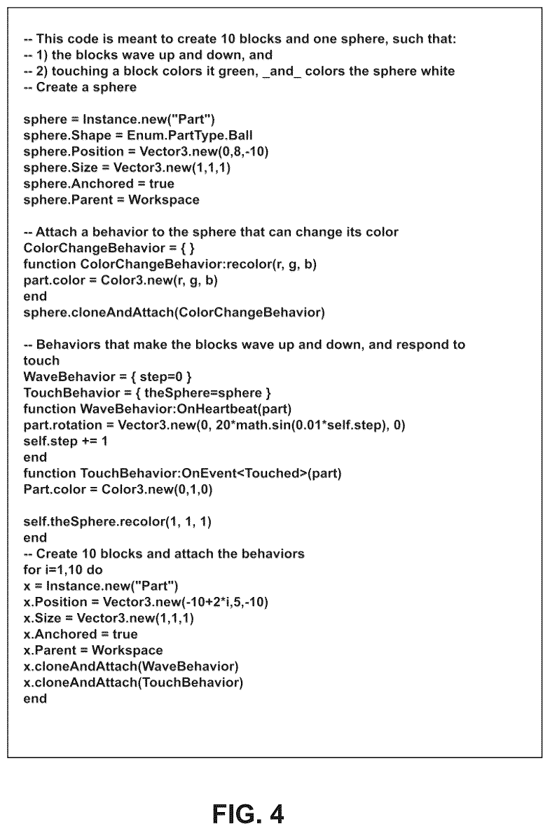

FIG. 4 is an example program (distributed script) that can be utilized to determine an object state of a virtual object, in accordance with some implementations.

In this illustrative example script, 10 blocks (where a block refers to a cube or other 3-dimensional object with four or more surfaces) and a sphere are generated such that the blocks wave up and down, and when a user is detected touching a block, the block is colored green, and the sphere is colored white.

Block 305 may be followed by block 310. At block 310, an updated object state for the virtual object is generated for a first time-step by executing the program on a processor of the client device.

In some implementations, the updated object state for the virtual object is generated based on speculative execution of the program by the processor of the client device. In some implementations, the updated object state for the virtual object is generated based on authoritative execution of the program at the processor of the client device. Generation of the updated object state for a virtual object at a processor of the client device can avoid any delays incurred due to latency issues that may be encountered when an updated object state is determined at another, e.g., server device, and has to be transmitted to the client device.

In some implementations, dynamic server authority may be utilized whereby client devices are enabled to determine object states for virtual objects at a client device, subject to verification of the accuracy and validity of the determined object states by the server device at periodic intervals. Periodic verification of the accuracy and validity of object states determined at the client device ensures that client devices are able to meet real-time computational requirements and to detect any unfair advantages realized by users of client devices.

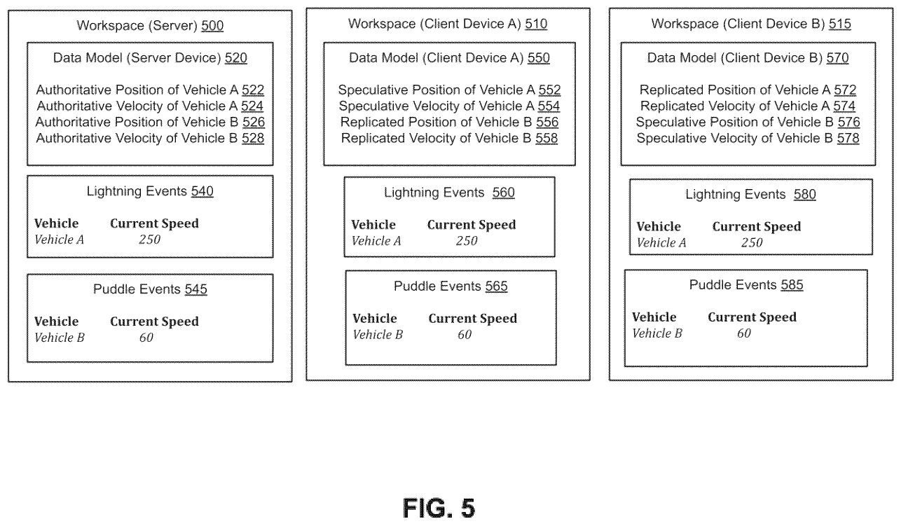

FIG. 5 depicts example object states of virtual objects stored in a workspace (memory) of a server device and a workspace (memory) of client devices that are participating in an example virtual experience, in accordance with some implementations.

In this illustrative example, object states of virtual objects that were described with reference to FIG. 2A are depicted that are associated with a particular time, e.g., a time corresponding to the scene depicted in FIG. 2A. FIG. 5 depicts respective workspaces of a server device and participating client devices; Workspace (server) 500, Workspace (Client Device A) 510, and Workspace (Client Device B) 515.

In some implementations, the workspace of the server device includes a state of all virtual objects in the virtual experience whereas the workspace of a client device includes the state of virtual objects that may be relevant to that particular client device. The state of the virtual objects may be periodically synchronized between the server and one or more client devices.

In this illustrative example, workspace (server) 500 includes virtual objects that are included in data model (server device) 520, virtual objects denoted as lightning events 540 and puddle events 545. Workspace (Client Device A) 510 includes virtual objects that are included in data model (client device A) 550, virtual objects denoted as lightning events 560 and puddle events 565. Workspace (Client Device B) 515 includes virtual objects that are included in data model (client device B) 570, virtual objects denoted as lightning events 580 and puddle events 585.

In this illustrative example, the server device is denoted as the authoritative device for determining the object states of the race cars. Accordingly, the data model (server device) 520 stores a current value for variables that include authoritative position of vehicle A 522, authoritative velocity of vehicle A 524, authoritative position of vehicle B 526, and authoritative velocity of vehicle B 528.

The data model (client device A) 550 includes a current value for variables that include speculative position of vehicle A 552, speculative velocity of vehicle A 554, replicated position of vehicle B 556, and replicated velocity of vehicle B 558. The data model (client device B) 570 includes a current value for variables that include replicated position of vehicle A 572, replicated velocity of vehicle A 574, speculative position of vehicle B 576, and speculative velocity of vehicle B 578.

While a complete set of virtual objects is stored in a workspace of the server device 520, client devices may only store those virtual objects relevant to their context to conserve memory and other computational resources. Additionally, object states of some virtual objects may be speculatively determined at client devices in order to provide faster response times. For example, a virtual object whose state is authoritatively determined at a server device may have its object state speculatively determined at a local client device.

In this illustrative example where the virtual experience is a car racing game, the object state of the car, e.g., a velocity and position of each car, may be authoritatively determined at the server device. However, a client device of a participating client device may speculatively determine the object state(s) of a car associated with a player operating the particular client device. Speculative determination of the object state of the car may enable a superior user experience since the movement of the car can be rendered such that it appears more responsive to the user (since there is no latency cost associated with obtaining the object states from the server device).

In some implementations, the object state of an object associated with a first device may be replicated on other client devices, while in some other implementations, the object state of an object associated with a first device may be speculatively determined at other client devices.

In some implementations, speculative updates of an object state may be performed on a plurality of devices (e.g., all clients or a subset of clients could be speculating on the same virtual object). In some implementations, a server (or servers) may make a determination whether a client device is performing speculative updates or whether the client device is relying on replicated results from a server. In some implementations, a developer may provide an indicate regarding which objects are predictable (i.e. potentially predicted), and the virtual experience platform may determine whether the predictable object is actually predicted or not.

Block 310 may be followed by block 315. At block 315, the virtual experience may be caused to be displayed at the client device. The display may include rendering of one or more virtual objects and display of the virtual object in the virtual experience may be based on the updated object state determined, e.g., at block 310. In some implementations, the object state of the virtual object may be utilized to update the virtual experience in other ways, e.g., playback of a sound, updating an event tracker, updating a scoreboard or leaderboard, adjusting one or more attributes associated with the virtual experience, etc. Block 315 may be followed by block 320.

At block 320, an authoritative object state for the virtual object may be received from the server device. In some implementations, the authoritative object state of the virtual object is generated by executing the program on a processor of the server device. For example, the authoritative object state of the virtual object may be determined by executing the same program (distributed script) on a processor of the server device that was also previously executed at a processor of the client device. Block 320 may be followed by block 325.

At block 325, it is determined whether the authoritative object state for the virtual object matches the updated object state for the virtual object. As described earlier, in implementations of dynamic server authority, it is to be verified, e.g., periodically whether the speculative object state(s) determined for a virtual object matches an authoritative object state. In some implementations, predetermined thresholds may be utilized to determine whether the speculative object state(s) determined for a virtual object matches an authoritative object state, particularly for object states that are calculated, e.g., position, velocity, etc.

In some implementations, a frequency of the verification may be based on network conditions and the time required for client device(s) and server device(s) to process updates. A higher frequency may mitigate the impact of mispredictions (e.g., since any mispredictions are identified and rectified sooner), but can also consume more network bandwidth which may compete for bandwidth with other operations or even exceed the available bandwidth.

In some implementations, determining whether the authoritative object state for the virtual object matches the updated object state for the virtual object may include comparing the authoritative object state for the virtual object and the updated object state based on an elapsed time from the first time-step to a current time.

In some implementations, a history (e.g., the last N seconds of simulation time) may be stored at a client device for one or more predictable states that are speculatively determined at the client device. In some implementations, a complete snapshot of the speculatively determined states may be stored on the client for each simulated step of the simulation. In some implementations, a client device may only store hashes of object state(s) in order to detect if predicted state differs from an authoritative state. When an update is received from a server with a particular time stamp, the speculated values (or a hash of those values) may be retrieved from the history of the client device to perform a comparison to determine if the authoritative and speculated states match. In some implementations, two states which are close to each other (e.g. within a predetermined distance metric) may be considered be equal to avoid mispredictions.

If it is determined at block 325 that the authoritative object state for the virtual object matches the updated object state for the virtual object, block 325 is followed by block 330, else block 325 is followed by block 335.

At block 330, based on a determination that the authoritative object state for the virtual object matches the updated object state for the virtual object, method 300 may be terminated for the first time-step, and may proceed to a subsequent time step. In some implementations, the updated object state which was previously marked as being speculative is now considered to be an authoritative object state.

At block 335, based on a determination that the authoritative object state for the virtual object does not match the updated object state for the virtual object, the virtual experience is caused to be displayed at the client device based on the authoritative object state. For example, if it is determined that the virtual object does not match the updated object state for the virtual object (e.g., when the object state is mispredicted), the client device may roll back the simulation to the time of the authoritative update. One or more mispredicted state(s) may be updated with authoritative updates. However, since the simulation is now corresponding to a point in the past (compared to what has been most recently displayed to the user), the simulation may be resimulated from the time stamp of the authoritative update using the updated state and also accompanied by reapplying any inputs from the user that are newer than the authoritative update. In some implementations, after the simulation has resimulated up to the client's current time, a display may be updated based on the object state(s) determined via resimulation.

In some implementations, when a speculated state (speculatively determined state) does not match an authoritative update, the following operations may be performed. The client state is rolled back to the same time stamp as the authoritative update using a mixture of an authoritative update from the server (the last change that the server experienced) and a cache of historic states on the client. Authoritative updates are applied to the state. The simulation is now advanced (resimulated) from the time stamp for the roll back until it reaches the current frame.

During resimulation, other updates (e.g., messages sent to distributed scripts) may also be replayed at the appropriate time in the simulation.

In some implementations, the entire state of the simulation is not rolled back and resimulated. For example, if the mismatch is relatively small, then it may only be necessary to resimulate a portion of the virtual world that is influenced by the mismatch. During resimulation a set of objects being resimulated may be expanded if it is determined that changes introduced during resimulation may affect objects outside the initial set of objects used for resimulation.

Block 335 may be followed by block 330 to proceed to a subsequent-time-step. For example, at block 330, after a first time-step execution of method 300, the time-step may be incremented to a second time-step and the method may be proceed to 310 for the second time-step. In some implementations, if it is determined that the program version has changed (e.g., through a notification from a server device), after execution of block 330, block 305 may be performed to obtain the new version of the program.

In some implementations, the program may be associated with a scope (e.g., data access scope) that defines a subset of elements from elements in a data model of the virtual experience that are accessible by the program without incurring a time delay. Elements outside the defined scope may be accessed by the program, but by incurring a time delay and without a guarantee of freshness of data. In some implementations, the scope may be based on a total number of the elements in the data model of the virtual experience. For example, method 300 may further include transmitting to a server device, a request for access to a second virtual object that is not included in the scope. In such a scenario, the client device may receive a second object state for the second virtual object that is associated with an elapsed time that precedes the first time-step. For example, the second object state may be associated with a timestamp that precedes the first time-step.

As described earlier, in some scenarios, the speculative object states that are determined by a client device may be erroneous. In some implementations, periodic verification of speculative execution of the program at a client device may be performed to determine whether the speculative execution should be continued at the client device. In some implementations, repeated instances of speculatively determined object states for a virtual object not matching authoritative object states for the virtual object may be utilized to determine that speculative execution should be suspended at the client device.

For example, consider an illustrative scenario where for a first time-step an updated object state determined speculatively does not match an authoritative object step. In such a scenario, the program may be executed at the client device at a second time-step to generate a second updated object state for the virtual object.

Subsequently, a second authoritative object state for the virtual object may be received at the client device from the server device. It may be determined whether the second authoritative object state for the virtual object matches the second updated object state for the virtual object. Based on a determination that the second authoritative object state for the virtual object does not match the second updated object state for the virtual object, the execution of the program may be suspended at the client device. In some implementations, a threshold number of mispredictions over a short period of time may be a criterion to determine that execution of the program is to be suspected at the client device.

In some implementations, when speculative execution is suspended at a client device, the virtual experience is caused to be displayed at the client device based on authoritative object state(s) of the virtual object received from the server device. In some implementations, when speculative execution is suspended at a client device, the virtual experience is caused to be displayed at the client device based on object state(s) of the virtual object replicated (received) from other client devices. In some implementations, display of one or more virtual objects may be ceased when speculative execution is suspended at the client device.

In some implementations, method 300 may be performed for virtual experiences that are hosted by a single server device and in which players participate via multiple client devices. For example, in addition to speculative execution of the program at a first client device, the same program may be executed at a second client device of a second user that participates in the virtual experience, where executing the program at the second client device includes generating a second updated object state for the virtual object.

Subsequent to the generation of the second updated object state for the virtual object, the virtual experience may be caused to be displayed at the second client device, wherein the virtual object is displayed in the virtual experience with the second updated object state.

In some implementations, the updated object state (determined at a first client device) and the second updated object state (determined at a second client device) may be different. It may further be determined, utilizing rollback and/or resimulation, whether either of the updated object state and the second updated object state match the authoritative object state, and speculative execution of the program may be continued at the client device where the object states match, while the client device without a match of the object states may continue to utilize the authoritative object state.

For example, in a scenario where it is determined that the second updated object state matches an authoritative object state for the virtual object computed by the server device, the authoritative object state may be utilized at the first client device.

In some implementations, object states determined at the server device may be used when a client device joins a virtual experience, while subsequent determination of object states may be performed at the client device. This may enable a user associated with the client device to join the virtual experience without delay (since the object states are obtained from the server device) and provide a superior user experience.

For example, for a first time-step that is associated with a time of the client device joining the virtual experience, method 300 may include receiving an initial object state for the virtual object from the server device prior to executing the program on the processor of the client device, and causing the virtual experience to be displayed at the client device based on the initial object state. Once the data model is loaded onto the client device, execution of the program may be performed for subsequent time steps.

Method 300, or portions thereof, may be repeated any number of times using additional inputs. Blocks 305-335 may be performed (or repeated) in a different order than described above and/or one or more steps can be omitted. For example, block 305 may be omitted in some implementations where the program is already loaded into memory. In some implementations, blocks 320, 325, and 335 may not be performed (for one or more time-steps) and in some implementations, block 315 may be followed directly by block 330. In some implementations, block 325 may be followed by block 315 for a subsequent time step when it is determined that the authoritative object state for the virtual object matches the updated object state for the virtual object.

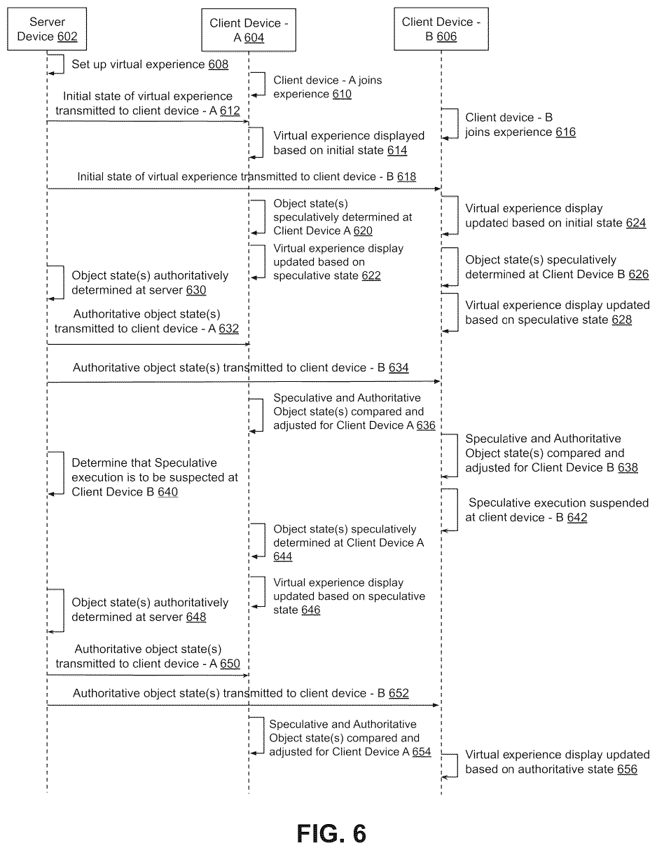

FIG. 6 illustrates various stages of the updation and display of virtual objects during an implementation of dynamic server authority in a virtual experience, in accordance with some implementations.

In this illustrative example, dynamic server authority is implemented in a client-server environment that includes a server device 602, a client device A 604, and a client device B 606.

At stage 608, a virtual experience is set up at the server device. At stage 610, a client device A 604 joins the virtual experience. In response to client device A 604 joining the virtual experience, an initial state of virtual objects in the virtual experience is transmitted to the client device A 604 at stage 612.

Based on the received initial state, the virtual experience may be displayed (614) at client device A 604. At stage 616, a second client device, Client Device B 606 may join the virtual experience. In response to client device B 606 joining the virtual experience, an initial state of virtual objects in the virtual experience is transmitted to the client device B 606 at stage 618. The virtual experience may be displayed 624 at client device B 606.

Subsequent to the initialization, the client devices may perform speculative execution of a program (distributed script) to determine virtual object states. Accordingly, at stage 620, object state(s) may be speculatively determined at Client Device A 604. At stage 622, the virtual experience display on client device A 604 may be updated based on the speculatively determined object state (by execution of the distributed script at a processor of client device A 604).

At stage 626, object state(s) of virtual object(s) may be speculatively determined at client device B 606. At stage 628, the virtual experience display on client device B 606 may be updated based on the speculatively determined object state (by execution of the distributed script at a processor of client device B 606).

At stage 630, the object state(s) may be authoritatively determined at server device 602 by executing the distributed script at a processor of server device 602. The authoritatively determined object state(s) may be transmitted to client device A 604 at stage 632 and to client device B 606 at stage 634.

At stage 636, the speculatively determined object state(s) and the authoritative object state(s) may be compared and suitably adjusted for Client Device A 604. For example, if it is determined that the speculatively determined object state(s) and the authoritative object state(s) match, then it may be inferred that the speculative execution is performing as expected and may be continued.

At stage 638, the speculatively determined object state(s) and the authoritative object state(s) may be compared and suitably adjusted for Client Device B 606. In this illustrative example, at stage 640, it may be determined that the speculatively determined object state(s) at client device B 606 and the authoritative object state(s) do not match, and that speculative execution is to be suspended at client device B 606. At stage 642, speculative execution is suspended at client device B 606 and subsequent updates of the display on client device B 606 is based only on authoritative updates received from the server device 602.

At stage 644, object state(s) may be speculatively determined at Client Device A 604. At stage 646, the virtual experience display on client device A 604 may be updated based on the speculatively determined object state (by execution of the distributed script at a processor of client device A 604).

At stage 648, the object state(s) may be authoritatively determined for a subsequent time-step at server device 602 by executing the distributed script at a processor of server device 602. The authoritatively determined object state(s) for the subsequent time-step may be transmitted to client device A 604 at stage 650 and to client device B 606 at stage 652.

At stage 654 the speculatively determined object state(s) and the authoritative object state(s) may be compared and suitably adjusted for Client Device A 604. At stage 656, the virtual experience display on client device B 606 may be updated based on the received authoritative object state(s) (since speculative execution of the distributed script is suspended.

Stages 608-656 may be repeated any number of times using additional inputs and/or may be performed (or repeated) in a different order than described above and/or one or more stages can be omitted.

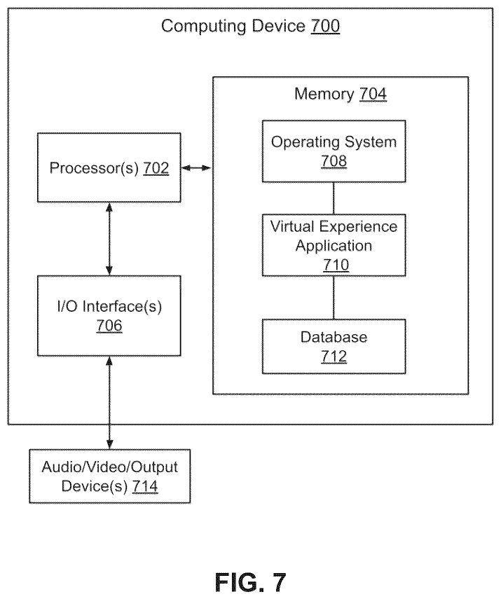

FIG. 7 illustrates an example computing device, in accordance with some implementations.

In one example, device 700 may be used to implement a computer device (e.g. 102, 110, and/or 130 of FIG. 1), and perform suitable method implementations described herein. Computing device 700 can be any suitable computer system, server, or other electronic or hardware device. For example, the computing device 700 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 700 includes a processor 702, a memory 704, input/output (I/O) interface 706, and audio/video input/output devices 714.

Processor 702 can be one or more processors, processing devices, and/or processing circuits to execute program code and control basic operations of the device 700. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, one or more applications 710, e.g., an audio spatialization application, a sound application, content management application, and application data 712. In some implementations, application 77 can include instructions that enable processor 702 to perform the functions (or control the functions of) described herein, e.g., some or all of the methods described with respect to FIG. 3.

For example, applications 710 can include an audio spatialization module which as described herein can provide audio spatialization within an online virtual experience server (e.g., 102). Any software in memory 704 can alternatively be stored on any other suitable storage location or computer-readable medium. In addition, memory 704 (and/or other connected storage device(s)) can store instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. For example, network communication devices, storage devices (e.g., memory and/or data store 120), and input/output devices can communicate via interface 706. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 714 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 7 shows one block that is representative of each processor 702, memory 704, I/O interface 706, and software blocks 708 and 710. These blocks may represent one or more processors, computing instances on distributed computing systems, processing devices, or processing circuitries, operating systems, memories, I/O interfaces, applications, and/or software engines. In other implementations, device 700 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the device 700, e.g., processor(s) 702, memory 704, and I/O interface 706. An operating system, software and applications suitable for the user device can be provided in memory and used by the processor. The I/O interface for a user device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 714, for example, can be connected to (or included in) the device 700 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 300, etc.) can be implemented by computer program instructions or code, which can be executed on a computer. For example, the code can be implemented by one or more digital processors (e.g., microprocessors or other processing circuitry), and can be stored on a computer program product including a non-transitory computer-readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a user device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method, comprising:
obtaining, at a client device of a user that participates in a virtual experience hosted by a server device, a program that is executable at the client device and that operates on a virtual object that is part of the virtual experience, wherein the virtual object is associated with an object state;
generating an updated object state for the virtual object for a first time-step by executing the program on a processor of the client device;
after the generating, causing the virtual experience to be displayed at the client device, wherein the virtual object is displayed in the virtual experience based on the updated object state;
receiving an authoritative object state for the virtual object from the server device;
determining whether the authoritative object state for the virtual object matches the updated object state for the virtual object; and
based on a determination that the authoritative object state for the virtual object does not match the updated object state for the virtual object, causing the virtual experience to be displayed at the client device based on the authoritative object state.

2. The computer-implemented method of claim 1, wherein the program is associated with a scope that defines a subset of elements from elements in a data model of the virtual experience that are accessible by the program, and wherein the scope is based on a total number of the elements in the data model of the virtual experience.

3. The computer-implemented method of claim 2, further comprising:
transmitting to the server device, a request for access to a second virtual object that is not included in the scope; and
receiving a second object state for the second virtual object, the second object state associated with a timestamp that precedes the first time-step.

4. The computer-implemented method of claim 1, wherein determining whether the authoritative object state for the virtual object matches the updated object state for the virtual object comprises comparing the authoritative object state and the updated object state based on an elapsed time from the first time-step to a current time at which the determining is performed.

5. The computer-implemented method of claim 1, further comprising:
executing the program at the client device at a second time-step to generate a second updated object state for the virtual object;
receiving, at the client device, a second authoritative object state for the virtual object from the server device;
determining whether the second authoritative object state for the virtual object matches the second updated object state for the virtual object; and
based on a determination that the second authoritative object state for the virtual object does not match the second updated object state for the virtual object, suspending execution of the program at the client device.

6. The computer-implemented method of claim 5, further comprising causing the virtual experience to be displayed at the client device based on the second authoritative object state for the virtual object received from the server device.

7. The computer-implemented method of claim 1, further comprising executing the program at a second client device of a second user that participates in the virtual experience, wherein executing the program at the second client device comprises generating a second updated object state for the virtual object and after the generating, causing the virtual experience to be displayed at the second client device, wherein the virtual object is displayed in the virtual experience with the second updated object state.

8. The computer-implemented method of claim 7, wherein the updated object state and the second updated object state are different, and wherein the method further comprises:
determining that the second updated object state matches an authoritative object state for the virtual object; and
in response to determining that the second updated object state matches the authoritative object state, receiving at the client device the authoritative object state.

9. The computer-implemented method of claim 1, wherein the virtual object comprises at least one of an avatar, a sound, a texture, a chat message, or a combination thereof.

10. The computer-implemented method of claim 9, wherein the virtual object is an avatar, and wherein the updated object state comprises one or more of a position of the avatar in the virtual experience, a velocity of the avatar in the virtual experience, or a combination thereof.

11. The computer-implemented method of claim 1, wherein the first time-step is associated with a time of the client device joining the virtual experience, and wherein the method further comprises:
prior to executing the program on the processor of the client device, receiving an initial object state for the virtual object from the server device; and
causing the virtual experience to be displayed at the client device based on the initial object state.

12. A non-transitory computer-readable medium with instructions stored thereon that, upon execution by a processing device, cause the processing device to perform operations comprising:
obtaining, at a client device of a user that participates in a virtual experience hosted by a server device, a program that is executable at the client device and that operates on a virtual object that is part of the virtual experience, wherein the virtual object is associated with an object state;
generating an updated object state for the virtual object for a first time-step by executing the program on a processor of the client device;
after the generating, causing the virtual experience to be displayed at the client device, wherein the virtual object is displayed in the virtual experience based on the updated object state;
receiving an authoritative object state for the virtual object from the server device;
determining whether the authoritative object state for the virtual object matches the updated object state for the virtual object; and
based on a determination that the authoritative object state for the virtual object does not match the updated object state for the virtual object, causing the virtual experience to be displayed at the client device based on the authoritative object state.

13. The non-transitory computer-readable medium of claim 12, wherein the program is associated with a scope that defines a subset of elements from elements in a data model of the virtual experience that are accessible by the program, and wherein the scope is based on a total number of the elements in the data model of the virtual experience.

14. The non-transitory computer-readable medium of claim 13, wherein the operations further comprise:
transmitting to the server device, a request for access to a second virtual object that is not included in the scope; and
receiving a second object state for the second virtual object, the second object state associated with a timestamp that precedes the first time-step.

15. The non-transitory computer-readable medium of claim 12, wherein determining whether the authoritative object state for the virtual object matches the updated object state for the virtual object comprises comparing the authoritative object state and the updated object state based on an elapsed time from the first time-step to a current time at which the determining is performed.

16. A system comprising:
a memory with instructions stored thereon; and
a processing device, coupled to the memory, the processing device configured to access the memory and execute the instructions, wherein the instructions cause the processing device to perform operations comprising:
obtaining, at a client device of a user that participates in a virtual experience hosted by a server device, a program that is executable at the client device and that operates on a virtual object that is part of the virtual experience, wherein the virtual object is associated with an object state;
generating an updated object state for the virtual object for a first time-step by executing the program on a processor of the client device;
after the generating, causing the virtual experience to be displayed at the client device, wherein the virtual object is displayed in the virtual experience based on the updated object state;
receiving an authoritative object state for the virtual object from the server device;
determining whether the authoritative object state for the virtual object matches the updated object state for the virtual object; and
based on a determination that the authoritative object state for the virtual object does not match the updated object state for the virtual object, causing the virtual experience to be displayed at the client device based on the authoritative object state.

17. The system of claim 16, wherein the operations further comprise executing the program at a second client device of a second user that participates in the virtual experience, wherein executing the program at the second client device comprises generating a second updated object state for the virtual object and after the generating, causing the virtual experience to be displayed at the second client device, wherein the virtual object is displayed in the virtual experience with the second updated object state.

18. The system of claim 16, wherein the virtual object comprises at least one of an avatar, a sound, a texture, a chat message, or a combination thereof.

19. The system of claim 18, wherein the virtual object is an avatar, and wherein the updated object state comprises one or more of a position of the avatar in the virtual experience, a velocity of the avatar in the virtual experience, or a combination thereof.

20. The system of claim 16, wherein the first time-step is associated with a time of the client device joining the virtual experience, and wherein the operations further comprise:
prior to executing the program on the processor of the client device, receiving an initial object state for the virtual object from the server device; and
causing the virtual experience to be displayed at the client device based on the initial object state.
